(19) United States
(12) Patent Application Publication
(10) Pub. No.: US 2009/0322760 A1
(43) Pub. Date: Dec. 31, 2009

(54) Dynamic animation scheduling

(75) Inventors: Paul J. Kwiatkowski, Bellevue, WA (US); Sankhyayan Debnath, Redmond, WA (US); Jay E. Turney, Seattle, WA (US); Martyn S. Lovell, Seattle, WA (US); Billie Sue Chafins, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/146,848

(22) Filed: Jun. 26, 2008

(51) Int. Cl. G06T 13/00

(52) U.S. Cl. 345/473

(57) ABSTRACT

Dynamic animation scheduling techniques are described in which application callbacks are employed to permit dynamic scheduling of animations. An application may create a storyboard that defines an animation as transitions applied to a set of variables. The storyboard may be communicated to an animation component configured to schedule the storyboard. The animation component may then communicate one or more callbacks at various times to the application that describe a state of the variables. Based on the callbacks, the application may specify changes, additions, deletions, and/or other modifications to dynamically modify the storyboard. To draw the animation, the application may communicate a get variable values command to the animation component. The animation component performs calculations to update the variable values based on the storyboard and communicates the results to the application. The application may then cause output of the animation defined by the storyboard.

### BACKGROUND

User interfaces provided by various applications may employ animations, visual effects, audio, and other content that changes over time. For example, animations may be initiated responsive to user input, such as exposing a drop-down menu when a user selects a menu bar item or presses a corresponding key of a keyboard. Traditional techniques for animations that occur responsive to user input involve immediate display of animation results. Traditional animation techniques may also involve static changes between one state and another state. Accordingly, the ability to produce sophisticated animations using traditional animation techniques is limited.

### SUMMARY

Dynamic animation scheduling techniques are described in which application callbacks are employed to permit dynamic scheduling of animations. An application may create a storyboard that defines an animation as transitions applied to a set of variables. The storyboard may be communicated to an animation component configured to schedule the storyboard. The animation component may then communicate one or more callbacks to the application that describe a state of the variables. Based on the callbacks, the application may specify changes, additions, deletions, and/or other modifications to dynamically modify the storyboard. To draw the animation, the application may communicate a get variable values command to the animation component. The animation component performs calculations to update the variable values on behalf of the application based on the storyboard. The animation component may then communicate the results to the application automatically and/or responsive to the application polling the variables to get the updated values. The application may then cause output of the animation defined by the storyboard.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 depicts an example environment in which dynamic animation scheduling techniques may be employed.

FIG. 2 depicts an example procedure in which an animation component provides one or more callbacks to dynamically schedule an animation.

FIG. 3 depicts another example procedure in which an animation component provides one or more callbacks to dynamically schedule an animation.

FIG. 4 depicts an example procedure in which an application employs dynamic animation scheduling techniques to output an animation.

### DETAILED DESCRIPTION

Overview

User interfaces provided by various applications may employ animations, visual effects, audio, and other content that changes over time. Animations may occur responsive to user input, such as exposing a drop-down menu when a user selects a menu bar item or presses a corresponding key of a keyboard. The ability to produce sophisticated animations using traditional animation techniques is limited.

Dynamic animation scheduling techniques are described in which application callbacks are employed to permit dynamic scheduling of animations. Animations may be defined in storyboards that relate variables of animatable objects to transitions for the variables. For example, to move an automobile image along a path across a display, x and y variables corresponding to the automobile image may be associated with a transition that defines the path. For instance, the transition may define the path according to a linear function in the form of y=mx+b. Applications may use storyboards to create associations between a variety of variables and transitions to achieve a wide variety of animations.

The storyboards defining animations may be communicated to an animation component configured to schedule the storyboard. In order to permit the application to dynamically change a scheduled animation, the animation component may communicate one or more callbacks to the application that describe an animation state of the variables. In the above automobile image example, a callback may be communicated to provide the application with initial values for the x and y variables along with other information, such as direction, velocity, and so forth. Based on the callback from the animation component, the application may specify changes, additions, deletions, and/or other updates to dynamically modify the storyboard.

For example, when the automobile image is already in motion due to another animation, the application may choose to match the current velocity so that the animation does not appear choppy. In another example, the application may set velocity for the animation based on how far away the automobile image is expected to be from its destination. In yet another example, an interceding storyboard that defines another animation may be scheduled to cause the automobile image to change directions or end up at a different destination. In this case, a callback communicated by animation component may enable the application to understand the interceding changes. In response, the application might choose to complete the first animation and then begin the interceding animation, to merge the two animations, to output an additional storyboard that supersedes the others, and so forth.

Further, the animation component may track changes made by an application during the callbacks, such as by generating a tracking log. The animation component may employ the tracking log to undo or rollback any modifications made by an application during a callback based upon conditions and/or changes in conditions. This enables the animation component to create a schedule of animations predicatively based upon assumptions and to modify the schedule accordingly when the assumptions are determined to be invalid.

For example, an application may modify a storyboard during a callback to increase the velocity for the automobile animation based upon how far away the automobile image is expected to be from its destination. The animation component may store data in a tracking log to track the modifications (increased velocity) made by the application. Following scheduling of the storyboard, animation component may determine that the automobile image will actually be closer than expected to the destination when the storyboard is scheduled to begin. The animation component may use the tracking log to undo the modification made during the callback based upon the new expectations for the position of the automobile image. The animation component may then make another callback to the application with the new expectations (e.g., updated variable state) and the application may respond accordingly, such as by defining a decreased velocity for the automobile animation.

Thus, the callbacks provide a mechanism by which applications may dynamically understand conditions and/or changes in conditions (e.g., the animation state) that may affect animations defined by storyboards and modify the storyboards accordingly. The applications schedule animations through storyboards and may respond to corresponding callbacks with modifications to the storyboards. The processing may be offloaded to the animation component which handles the computations, scheduling, modifications, tracking, and undoing of modifications for the storyboards. In this manner, applications may rely on the animation component for processing storyboards and may operate without awareness of, tracking, or otherwise being concerned with what happens to storyboards once they have been scheduled and/or modified.

In the following discussion, an example environment is first described that is operable to perform dynamic animation scheduling techniques. Example procedures are then described that may be employed in the example environment, as well as in other environments. While aspects are described herein in relation to output of images and graphics, it is contemplated that the techniques may be employed with scheduling for a variety of content including graphics, text, audio, video and combinations thereof. Although these techniques are described as employed within an example computing environment in the following discussion, it should be readily apparent that these techniques may be incorporated within a variety of environments without departing from the spirit and scope thereof.

Example Environment

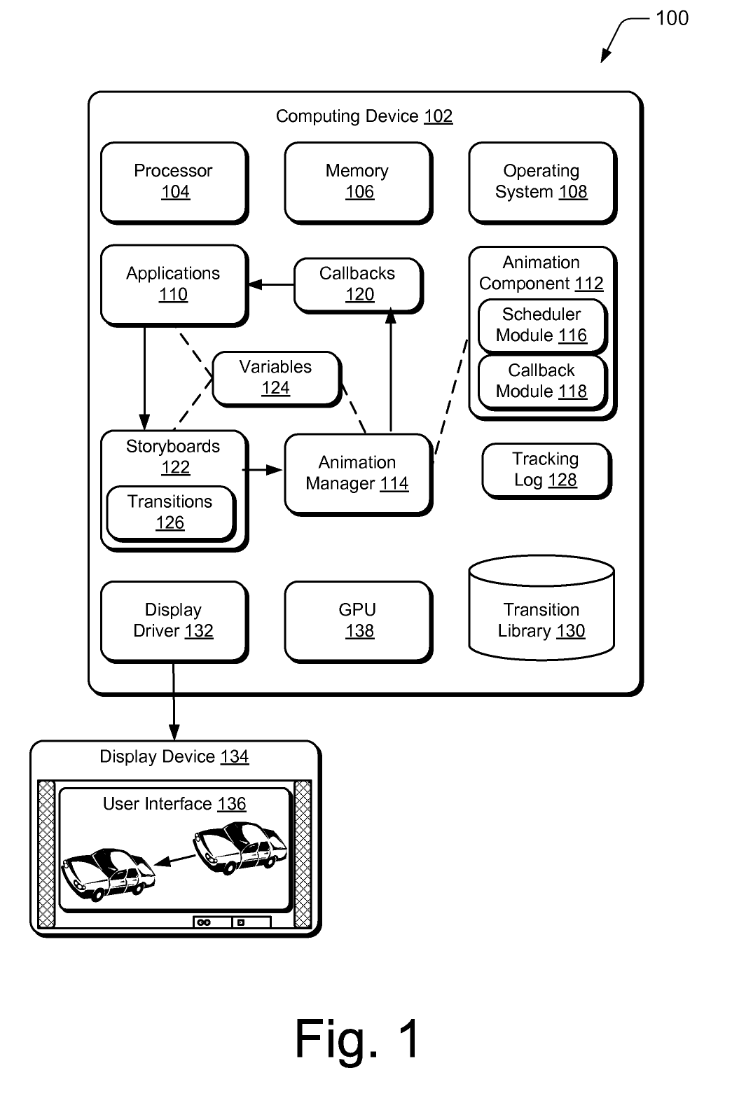

FIG. 1 is an illustration of an environment 100 in an example implementation that is operable to employ dynamic animation scheduling techniques described herein. The illustrated environment 100 includes a computing device 102 having one or more processors 104 and a memory 106. Computing device 102 may be configured in a variety of ways. For example, computing device 102 may be configured as a computer that is capable of communicating over a network, such as a desktop computer, a mobile station, a laptop, an entertainment appliance, a set-top box communicatively coupled to a display device, a wireless phone, a game console, and so forth. In the following description a referenced component, such as computing device 102, may refer to one or more entities. Therefore, by convention, reference may be made to a single entity (e.g., the computing device 102) or multiple entities (e.g., the computing devices 102, the plurality of computing devices 102, and so on) using the same reference number.

Processors 104 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. The one or more processors 104 may perform single threaded and multi-threaded operations. Additionally, although a single memory 106 is shown for the computing device 102, a wide variety of types and combinations of computer readable memories may be employed including volatile and non-volatile memory and/or storage media. For example, computer readable memories/media may include but are not limited to random access memory (RAM), hard disk memory, read only memory (ROM), flash memory, video memory, removable medium memory, and other types of computer-readable memories/media that are typically associated with a computing device 102 to store data, executable instructions, and the like.

The computing device 102 is further illustrated as including an operating system 108 and a variety of applications 110. The one or more processors 104 may retrieve and execute computer-program instructions from applications 110 to provide a wide range of functionality to the computing device 102, including but not limited to office productivity, email, media management, printing, networking, web-browsing, and so forth. A variety of program data related to the applications 110 is contemplated examples of which include office documents, multimedia files, emails, data files, web pages, user profile and/or preference data, and so forth.

Computing device 102 may also include various interfaces through which applications 110 may interact with the operating system 108, common resources, dynamic link libraries (DLLs), networks resources (content and services), and so forth. Interfaces may include a network interface through which application 110 may engage in various network interactions over a network (not shown) accessible to the computing device 102. Interfaces may also include one or more application programming interfaces (APIs) providing core tools and functions that may be used to take advantage of the functionality of the operating system 108. Generally, APIs are interfaces that various applications 110 may call to take advantage of various tools, resources, features, services, and so forth provided via the operating system 108. A variety of other examples are also contemplated.

Computing device 102 may also include an animation component 112 that is representative of variety of functionality, tools, and techniques related to providing animations for applications 110. Animation component 112 may be operable to manage various animations. Examples of functionality that may be provided by animation component 112 include but are not limited to: scheduling animations, performing calculations on behalf of applications 110, and/or generating feedback to applications to enable dynamic scheduling of animations. Thus, animation component 112 may provide a variety of functionality to enable applications 110 to offload scheduling and calculations for animations. Animation component 112 may be stored in memory 106 and executable on the processor 104. While it is illustrated as a stand-alone component, animation component 112 may also be integrated with the operating system 108. In an implementation, the animation component 112 may be provided as a dynamic link library (DLL) of the operating system 108. A variety of other examples are also contemplated.

Applications 110 may interact with the animation component 112 to perform dynamic animation scheduling through an animation manager 114. Animation manager 114 may be configured in a variety of ways to enable interaction between applications 110 and the animation component 112. In an implementation, animation manager 114 may be a communication object that is instantiated by an application 110 to take advantage of the features of the animation component 112. In a further implementation, the animation manager 114 may be configured as an interface (e.g., an application programming interface (API), Component Object Model (COM) object, or other suitable interface) that may be exposed by the operating system 108 and/or animation component 112. Thus, animation manager 114 may be representative of a variety of functionality operable to enable interaction between applications 110 and the animation component 112. In particular, animation manager 114 may be configured to facilitate a variety of communications between components to enable dynamic animation scheduling techniques described herein.

Applications 110 may communicate with the animation component 112 via the animation manager 114 to define animations, schedule animations, receive feedback regarding animations, offload animation calculations to the animation component 112, and request/receive animation calculations. A variety of other interaction to take advantage of features of the animation component 112 is also contemplated. Thus, features available from the animation component 112 may be callable by applications 110 via the animation manager 114.

Examples of some of the features that may be available from the animation component 112 include scheduling animations and updating of scheduled animations. For instance, animation component 112 is further illustrated as implementing a scheduler module 116 and a callback module 118. 118. The scheduler module 116 is representative of functionality operable to schedule various animations for the computing device 102. For example, the scheduler module 116 may manage an animation queue to control timing for various animations defined by applications 110.

The callback module 118 is representative of functionality operable to provide feedback to applications 110 regarding animations that have been scheduled. Based on this feedback, applications 110 may modify scheduled animations accordingly. For instance, callbacks 120 are illustrated in FIG. 1 that are representative of feedback that may be provided by the callback module 118 to applications 110. More particularly, the callbacks 120 may describe an animation state related to variables that define an animation. An animation state may include a variety of data corresponding to an animation, such as variable values, conditions, changes in conditions, data regarding related animations, and other data that may affect the animation. In an implementation, applications 110 may designate callbacks 120 to be performed by the animation component 112 via the storyboards 122. The animation component 112 may determine when to perform the callbacks 120 to communicate the animation state to the application. The callbacks 120 enable an application 110 receiving the callback 120 to make modifications to an animation based on the data describing the animation state. Thus, the callbacks 120 provide a mechanism by which applications 110 may be informed of and respond to dynamic changes in the animation state.

To schedule animations, an application 110 may create and/or output one or more storyboards 122. Storyboards 122 may be configured to define animations in terms of one or more variables 124 and one or more transitions 126 that may be applied to the variables 124. The variables 124 may be representative of various objects and/or attributes of the objects that may be animated. Applications 110 may create and destroy the variables 124 through the animation manager 114. The variables 124 may be referenced by applications 110, storyboards 122, and the animation component 114 to produce animations through the animation component 112. For example, variables 124 may correspond to user interface elements such as controls, menu items, graphics, text, and/or to attributes of the user interface elements such as color, size, screen position, transparency, velocity, and so forth.

Through storyboards 122, variables 124 may be associated with the transitions 126 to define animations for the corresponding objects and/or attributes. The transitions 126 describe ways in which the variables 124 may be animated. Transitions 126 may represent various abstractions of animations as mathematical functions that may be applied to change values of the variables 124. A variety of transitions 126 may be applied to variables 124 to create animations by changing values of the variables 124 according to linear, quadratic, polynomial, trigonometric, or other suitable functions.

For example, a transition 126 may indicate a linear change from a first value to a second value over time. When applied to a variable 124 corresponding to a color attribute of an object, this transition 126 will change the color of the corresponding object over time in accordance with the transition 126. In another example, a transition 126 may describe an oscillation between values according to a sinusoidal or other trigonometric function. Such a transition 126 may be applied to variables 124 to make an object move back and forth, appear and disappear, and so forth. Naturally, a variety of combinations of variables 124 and transitions 126 may be employed by applications in storyboards 122 to define a wide variety of animations.

During callbacks 120 various modifications may be made to storyboards 122. Modifications may be made at various times, whenever conditions or changes in conditions prompt a callback 120. In particular, applications 110 may modify transitions 126 applied to variables 124, add new transitions 126 and/or associations to variables 124, cancel storyboards 122, and so forth. Callback module 118 may also represent functionality of the animation component 112 to track modifications made by applications 110 during callbacks 120. For instance, callback module 118 may generate and maintain a tracking log 128 that includes data to track changes made during callbacks 120. The animation component 112 may employ the tracking log 128 to undo or rollback any modifications made by an application 110 during a callback 120 based upon conditions and/or changes in conditions. This enables the animation component 112 to create a schedule of animations predicatively based upon assumptions and to modify the schedule accordingly when the assumptions are determined to be invalid.

Computing device 102 is further illustrated as including a transition library 130. In an implementation, the transition library 130 may be managed via the animation component 112 to offload aspects of implementing storyboards 122 and transitions 126 from the applications 110. Transition library 130 may define transitions 126 that are recognizable by the animation component 112. The transition library 130 may further define code and functions used by animation component 112 to process storyboards 122.

Thus, the transitions 126 associated with storyboards 122 in FIG. 1 may represent references to the transition library 130 respectively. Rather than defining code and functions internally in each application 110 and/or storyboard 122, the storyboards 122 employed by applications 110 may be configured to define the associations between variables 124 and transitions 126 for an animation. Animation component 112 then makes use of the shared resources (e.g., transition library 130) to process the storyboards 122, perform calculations on behalf of applications 110, define classes of transitions 126, and so forth. Accordingly, the complexity of including code and functions for transitions 126 individually in each application 110 and/or storyboard 122 may be avoided.

Storyboards 122 may be created and integrated into an application 110 by a developer when the application 110 is developed. When executed, the application 110 may communicate the storyboards 122 to cause animations. For instance, the storyboards 122 may be communicated to the animation component 112, and more particularly to the scheduler module 116, which schedules the storyboards 122.

When the animation is scheduled, callback module 118 may operate to communicate a callback 120 to the application 110 which describes a state for the animation. In other words, callback module 118 may be configured to perform callbacks 120 which may involve various interactions with the application 110 to communicate various data. For instance, callbacks 120 and/or associated data (e.g., animation state) may be communicated at various times such as: initially when an animation is scheduled; when a callback 120 is scheduled by an application 110; when changes, conflicts, inputs or other triggers prompt a callback 120; when a different storyboard 112 is scheduled by the scheduler module; when a different storyboard 122 is removed from the schedule of animations; right before a time scheduled for the animation; and/or when a callback 120 is otherwise triggered. The callback 120 may include values for variables 124 involved in animation at the time of the callback 120, e.g., current conditions. Application 110 may use the callback 120 to determine when to update a corresponding storyboard 122.

Computing device 102 may output various animations that are defined by applications 110 through storyboards 122 and implemented though the animation component 112. For example, computing device 102 is illustrated as including a display driver 132 that enables output of the animations via a corresponding display 134. A variety of displays 134 are contemplated, such as an LCD display, a CRT monitor, a plasma display or other suitable displays 134. Display device 134 is illustrated as displaying a user interface 136 that may be output by an application 110. User interface 136 may include various animations produced in accordance with dynamic animation scheduling techniques described herein. For instance, user interface 136 in FIG. 1 depicts an example animation of an automobile moving across the display device 134.

In an implementation, computing device 102 may also include a dedicated graphics processing unit (GPU) 138 configured to perform various graphics processing/rendering tasks. Functionality provided by the GPU 138 may include controlling aspects of resolution, pixel shading operations, color depth, print rendering, texture mapping, animation draws, bitmap transfers and painting, image decoding, window resizing and repositioning, line drawing, font scaling, and other tasks associated with outputting of user interfaces 136, animations and/or other graphics. The GPU 138 may be capable of handling graphics processing tasks in hardware at greater speeds than software executed on the one or more processors 104. Thus, the dedicated processing capability of the GPU 138 may reduce the workload of the processors 104 and free up system resources for other tasks. The GPU 138 may be operated under the influence of the operating system 108, animation component 112, and/or an application 110 to process animations and output a user interface 136 for display via the display 134. In an implementation, animation component 112 may operate the GPU 138 to perform calculations on behalf of applications 110 using storyboards 122 provided by the applications 110.

Generally, the functions described herein can be implemented using software, firmware, hardware (e.g., fixed-logic circuitry), manual processing, or a combination of these implementations. The terms “module”, “functionality”, “engine” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer-readable memory devices. The features of the techniques to provide dynamic animation scheduling are platform independent, meaning that the techniques may be implemented on a variety of commercial computing platforms having a variety of processors.

Example Procedures

The following discussion describes techniques related to dynamic animation scheduling that may be implemented utilizing the previously described environment, systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference may be made to the example environment 100 of FIG. 1.

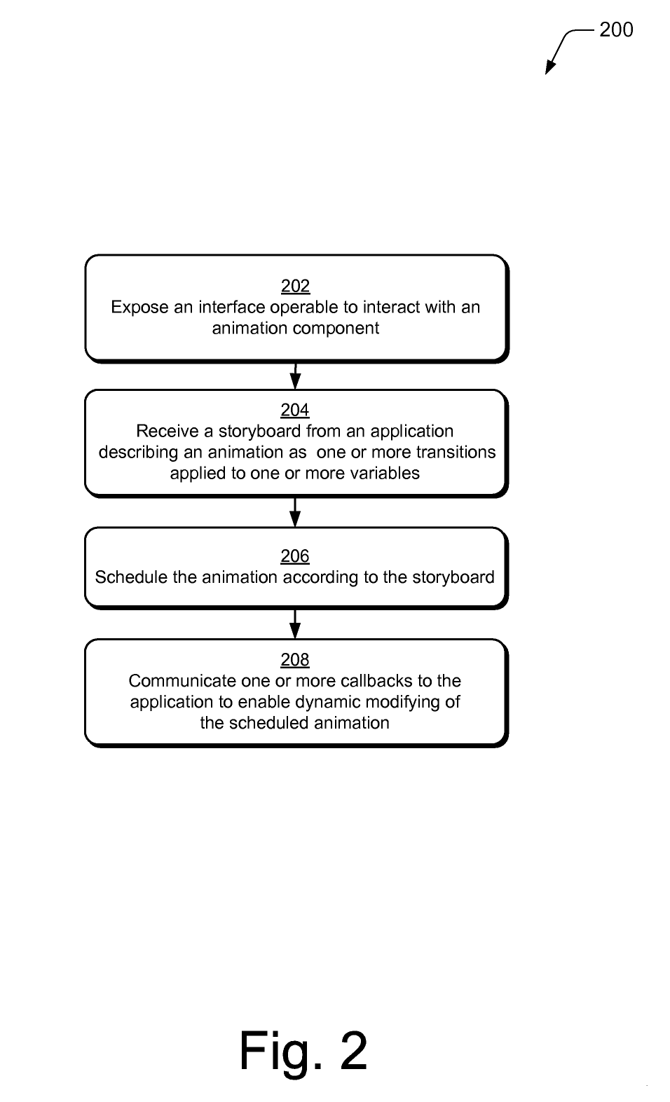

FIG. 2 depicts an example procedure 200 in which callbacks are employed to enable dynamic animation scheduling. An interface is exposed that is operable to interact with an animation component (block 202). For example, operating system 108 of a computer device 102 may expose an interface to provide interactions with animation component 112. Animation manager 114 of FIG. 1 is representative of various interfaces that may be exposed to enable applications 110 to interact with animation component 112. In particular, applications 110 may interact via the animation manager 114 to enable dynamic animation scheduling. In an implementation, animation manager 114 is representative of an application programming interface (API) that may be exposed via operating system 108. Animation manager 114 may also be configured as a communication object that is instantiated by an application 110 to enable interactions with the animation component 112. Various other techniques to provide an interface to enable interaction between applications 110 and animation component 112 are also contemplated.

A storyboard is received from an application that describes an animation as one or more transitions applied to one or more variables (block 204). For example an application 110 may output a storyboard 122 that defines an animation for a user interface 136. For the purpose of this example, assume that the storyboard 122 describes an animation in which a menu moves from off-screen to a central screen position over a period of time. To achieve the animation, the storyboard 122 may relate variables 124 for the menu, e.g., x position and y position, to transitions 126 that describe how to change the variables 124 over time. For instance, the transitions 126 may specify a curved path for the menu to follow, and/or a gradual increase in velocity as the menu approaches its destination. Moreover, the animation may be initiated responsive to user input, such a selection of an item on a menu bar of a user interface 136 that is output by the application. When input to cause the menu animation is received, application 110 may communicate the storyboard 122 describing the menu animation to the animation component 112 via the animation manager 114. Accordingly, animation component 112 may receive the storyboard 122 that defines the menu animation.

The animation is scheduled according to the storyboard (block 206). Continuing the preceding example, the animation defined by the received storyboard 122 may be processed via a scheduler module 116 of the animation component 112. Scheduler module 116 may be configured to add the menu animation to an animation queue that controls timing for a plurality of animations. Naturally, a variety of inputs may initiate a variety of different animations that may be managed by the animation component 112 and scheduled via scheduler module 116.

One or more callbacks are communicated to the application to enable dynamic modifying of the scheduled animation (block 208). In the ongoing example of the menu animation, consider another animation or conditions that may conflict with the scheduled menu animation. For example, a storyboard 122 may be scheduled (including callbacks 120) based on assumptions regarding the initial values for variables 124. For instance, the storyboard 122 may be based upon an earlier command that was scheduled to move the menu closer to its final destination before the storyboard 122 is scheduled to take effect. When the earlier command is canceled from the schedule, the assumptions of the closer position used to schedule the storyboard 122 may become invalid. Accordingly, the storyboard 122 may be re-done to take into account the larger distance to cover for the menu animation. In another example, the other animation may have been initiated to cause alignment of multiple menus across the bottom of the screen (e.g., user interface 136). In this scenario, the destination for the menu may change accordingly.

To inform the application 110 of such changes, animation component 112 may communicate one or more callbacks 120 to the application 110. For instance, communicating a callback 120 may include an animation component 112 performing a callback 120 to interact with an application 110 and provide data regarding current conditions and/or changes in conditions (e.g., a current animation state). As noted, callbacks 120 may be initiated in a variety of ways, such as being designated by applications 110 and passed to the animation component 112 via storyboards 122, generated based on changes in assumptions, introduced during another callback 120, and so forth. Animation component 112 may then perform the callbacks 120 responsive to a variety of triggers.

Animation component 112 may also use data maintained in a tracking log 128 to rollback the animation defined by the received storyboard 122 based upon changes in assumptions made when the storyboard 122 was scheduled. In this example, animation component 112 may understand from the conflicting animation that the destination for the menu has changed, may roll back or unschedule the storyboard, and/or may communicate the changes in a callback 120 to the application 110.

Responsive to this communication, application 110 may take action to modify the storyboard 122, which may include canceling, adding to, changing, or otherwise modifying the storyboard 122. In this example, the application 110 may determine to speed-up the menu animation or to move the menu directly to the new destination. Application 110 communicates modifications to the animation component 112. In an implementation, animation component 112 may track activities of the application 110 during a callback to understand modifications to a storyboard 112 that are prompted by the callback 112. Animation component 112 may then implement the modification in the corresponding storyboard 122, and track the modification in the tracking log 128 to enable undoing the modifications later.

As noted callbacks 120 may be performed at various times in response to a variety of triggers. In an implementation a callback 120 may be provided initially when a storyboard 122 is scheduled and thereafter whenever conditions or changes in conditions prompt a callback 120. Moreover animation component 112 may call any particular callback 120 multiple times as dictated by conditions or changes in conditions. Thus, there may be multiple callbacks 120 each of which may be communicated to an application 110 multiple times. Additionally, scheduling of conflicting animations (e.g., animations affecting the same variables) may generate a callback 120. Further, an application 110 may schedule a callback 120 to occur at a specified time. Such scheduled callbacks 120 may be designated via the storyboards 122. In another example, animation component 112 may generate callbacks 120 automatically just before a time to output a scheduled storyboard 122. For instance, a callback 120 may be automatically generated when a storyboard 122 reaches a certain position in the queue and/or at a defined amount of time before a scheduled time for a storyboard 122.

Further, multiple callbacks 120 and corresponding updates to a storyboard 122 may occur before the storyboard 122 is output. For instance, callbacks 120 may be made multiple times to undo/rollback changes and modify a storyboard 122 according to changes in conditions. Modifications to a storyboard 122 may be made at various times, whenever conditions or changes in conditions prompt a callback 120 by the animation component 112. Thus, multiple callbacks 120 may occur for a particular storyboard 122 based upon conditions and/or changes in conditions.

Further, applications 110 may include requests for callbacks 120 in a storyboard 122. For instance, an application 110 may construct a storyboard 122 to include one or more requests for callbacks 120. The callbacks 120 may be requested to occur for a time at a particular offset time from scheduling of the storyboard 122. Multiple callbacks 120 may be requested in the same storyboard 122 for different offsets. Further, each callback 120, when called, may cause additional callbacks 120 to be requested and/or added to the storyboard 122 for various offsets. Accordingly, multiple callbacks 120 may also occur for a particular storyboard 122 based upon requests made initially by applications 110 and/or when the storyboard 122 is modified during a callback 120.

Thus, through communication of callbacks 120 by the animation component 112, an application 110 is able to understand an animation state and make modifications to animations. Callbacks 120 and corresponding modifications may occur dynamically as various storyboards 122 are scheduled and/or inputs to initiate various animations are received. In other words, animation component 112 may dynamically modify scheduled animations whenever conditions or changes in conditions (e.g., the animation state) prompt callbacks 120 and corresponding changes by an application 110.

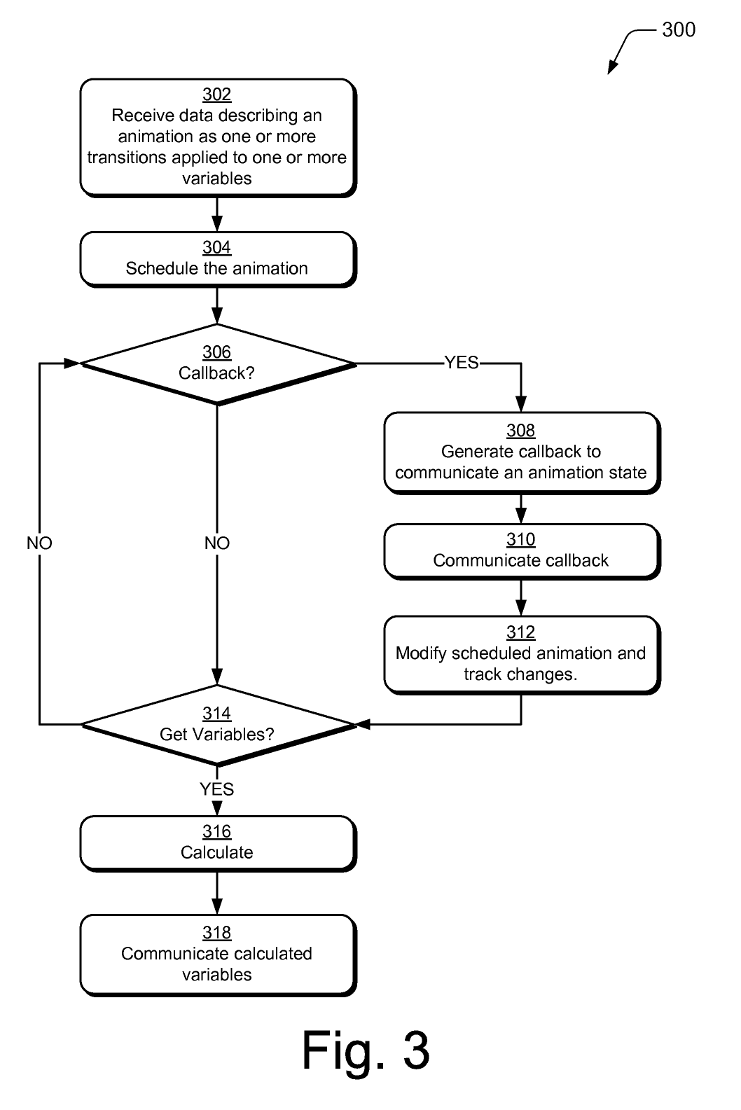

FIG. 3 depicts an example procedure 300 in which callbacks and calculations are provided to applications to enable dynamic animation scheduling. Data is received that describes an animation as one or more transitions applied to one or more variables (block 302). For example, an application 110 may communicate a storyboard 122 describing an animation for a user interface 136 that may be output by the application 110. Animation component 112 may receive the communicated storyboard 122 and perform various processing related to the described animation. More particularly, the animation may be described in the storyboard 122 by associations of variables 124 with transitions 126. Consider the illustrated example of the automobile moving across user interface 136 in FIG. 1. In this example, variables 124 corresponding to x position and y position of the automobile may be associated in the storyboard 112 with a transition 126 that implements a linear function to describe the path. A velocity for the animation may also be defined.

The animation is scheduled (block 304). For example, the automobile animation in the preceding example may be scheduled by a scheduler module 116 of the animation component 112. When an animation is scheduled, a determination of when to perform a callback is made (block 306). As discussed previously, callbacks 120 may be generated responsive to various prompts, inputs, conditions, and/or other triggers. Animation component 112 may receive, monitor, and/or process the various triggers to determine when to perform callbacks 120 to an application.

When animation component 112 determines to perform a callback, a callback is generated to communicate an animation state (block 308) and the callback is communicated (block 310). For instance, one or more callbacks 120 related to the example automobile animation may be generated by animation component 112 and communicated to the application 110. As previously noted, a callback 120 may be provided at various times to communicate an animation state to an application 110. The animation state may include data such as values of variables, conditions, changes in conditions, indications of conflicting animations, animation timing, and/or other information that may affect a scheduled storyboard 122. In the example automobile animation, a callback 120 may be communicated to provide initial values for the variables 124 describing the automobile animation in the storyboard 122, e.g. x position and y position.

The scheduled animation is modified and changes are tracked (block 312). For example, when an application 110 receives a callback 120, the application 110 may determine whether a modification is prompted. For instance, when x position and y position values communicated via a callback 120 indicate that the automobile image is already close to its intended destination, the application 110 may adjust how fast the animation occurs. In particular, the application 110 may modify the storyboard 122 to change the velocity with which the automobile image moves, such as by applying a different transition 126 to variables 124 for the x position and y position. Thus, responsive to a callback 120, an application 110 may communicate information to the animation component 112 to cause modifications to an associated storyboard 122. The animation component 112 may then make the modification to the storyboard 112 according to the information received from the application 110.

Further, animation component may track the interaction with the application 110 during the callback 120. In particular, tracking log 128 may be updated to reflect the modifications made to the storyboard 122 during the callback 120. Then, when assumptions used by the application 110 to adjust how fast the animation occurs are determined to be invalid, the animation component 112 may use the tracking log 128 to undo or rollback the changes. Assume that the animation component 112 determines that the assumption that the automobile was relatively close to the destination was incorrect. This may be based upon processing of an interceding animation that affects x position and y position values of the automobile image. In this case, animation component 112 may rollback the storyboard to undo the modification made during the previously described callback 120. Then, another callback 120 may be made to enable the application 110 to respond to the current x position and y position values of the automobile image. Thus, a cycle of repetitive callbacks 120, modifications, tracking, rollbacks, and so forth may be made between scheduling of a storyboard 122 and completion of the storyboard 122.

In this manner, the schedule of storyboards 122 may be predicatively generated and updated whenever conditions and/or changes in conditions prompt updating. Further, the processing of the storyboards 122 may be offloaded from applications 110 to the animation component 112. Such processing may include but is not limited to: performing computations, scheduling, sending callbacks 120, and tracking and undoing modifications made during callbacks 120. In this manner, applications 110 may operate without awareness of, tracking, understanding or otherwise being concerned with what happens to storyboards 112 once they have been scheduled or modified through interaction with the animation component 112.

Each interaction of an application 110 with animation component 112 in relation to a storyboard 122 (e.g., initial scheduling, callbacks 120, modifications, and so forth) may be substantially independent of other interactions made in relation to the storyboard 122. Animation component 112 may provide information (e.g., animation state) to enable decisions by an application 110 in regards to one interaction. When another interaction occurs (e.g., a callback 120), animation component 112 may provide application 110 with updated information (e.g., an updated animation state) to make decisions. For the standpoint of the application 110, the second interaction may be understood and handled as a separate and independent interaction from the first interaction.

When animation component 112 does not determine to perform a callback in block 306 and/or after completing the callback sequence represented by blocks 308-312, a determination of when to get variable values is made (block 314). For example, in addition to determining when callbacks 120 are to occur, animation component 112 may also operate to determine when to calculate and provide values of the variables 124 for an animation. For instance, animation component 112 may detect various triggers to determine when to calculate variables 124 for a frame of an animation. In one example, an application 110 may make a request to get variable values when it is time to draw a screen image (frame) to output the animation, such as output of the user interface 136 on the display 134. The get variable values request may cause animation manager to update a state of the variables 124 according to the associated transitions 126. Additionally or alternatively, functionality to control timing for animations may be provided by a stand-alone application and/or may be integrated with the animation component 112. Thus, animation component may be configured to respond to various triggers (e.g., get variable requests, timing controls, and so forth) to calculate and provide values of the variables 124 for an animation.

Thus, when get variable values is triggered, variables for an animation are calculated (block 316) and the calculated variables are communicated (block 318). For example, when an application 110 communicates a get variable values request for the automobile animation, the request may cause animation component 112 to calculate the associated variables 124 on behalf of the application 110. As noted, animation component 112 may reference a transition library 130 to process the storyboards 122, perform calculations on behalf of applications 110, and so forth. In this example, animation component 112 may perform calculations to obtain x position and y position values for the automobile animation according to a linear function that is defined by a transition 126. The animation component 112 may then communicate the calculated values to the application 110 through animation manager 114 or other suitable interface to enable the application 110 to draw the automobile animation.

When animation component 112 does not determine to get variable values in block 314, procedure 300 may return to block 306 where another callback determination may be made. It is to be noted that, while illustrated sequentially in FIG. 3, the callback determination (block 306) and get variables determination (block 314) by animation component 112 may occur in different orders, concurrently, and/or repetitively between scheduling of an animation and output of the animation. In other words, animation component 112 may continue to monitor and/or process triggers for each of callbacks 120 and calculation of variable values for an animation (e.g. scheduled storyboard 122) during the period of time that a corresponding storyboard 122 is in the animation queue.

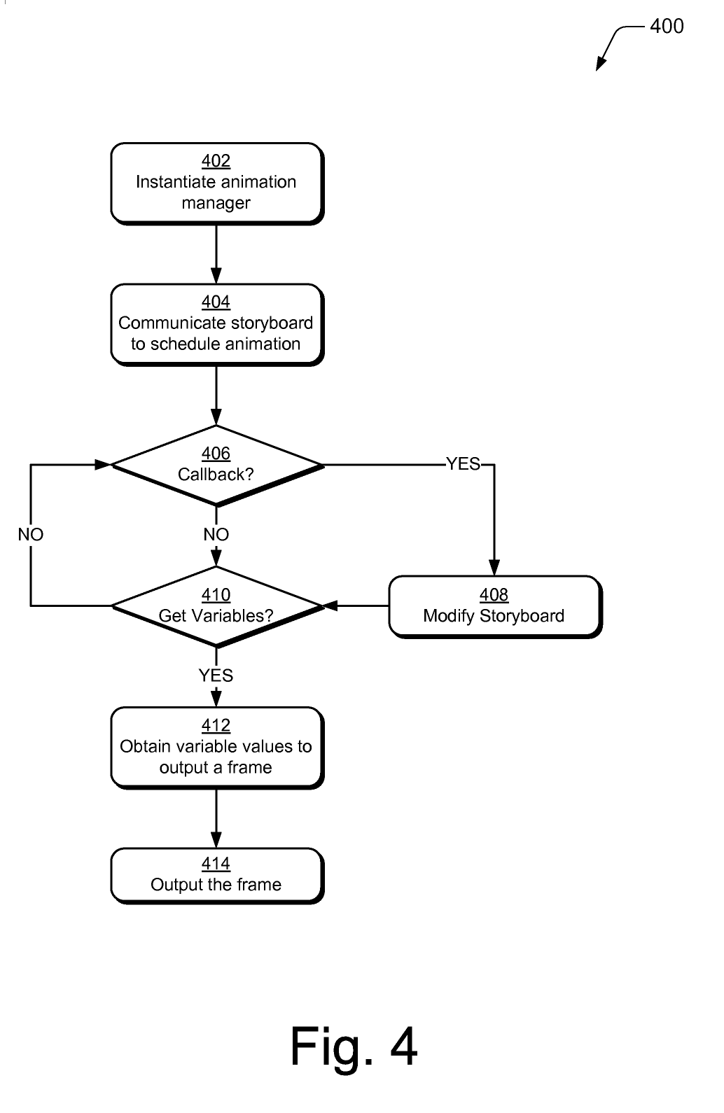

FIG. 4 depicts an example procedure 400 in which an application employs dynamic animation scheduling techniques. An animation manger is instantiated (block 402). For the purpose of example assume that an application 110 configured as a web browser is encoded to perform a variety of different animations. Examples of these different animations may include but are not limited to: menu items that slide out and/or expand when selected, rotating objects, a selectable control bar that scrolls at a varying speeds, and so forth. To output these and other animations, the web browser may take advantage of dynamic animation scheduling techniques described herein. To enable the animations, the web browser may interact with the operating system 108 and/or animation component 112 to instantiate an animation manager 114 through which dynamic animation scheduling techniques may be employed.

A storyboard is communicated to schedule an animation (block 404). For instance, the web browser of the preceding example may encode a variety of storyboards 122 to define the various different animations that may be output by the web browser. As noted previously, animations may be initiated responsive to various user inputs. For example, when input to cause scrolling of the selectable control bar is detected by the web browser, a corresponding storyboard 122 may be communicated by the web browser. More particularly, the storyboard 122 may be communicated via the animation manager 114 to the animation component 112. Then scheduler module 116 of the animation component 112 may operate to schedule the storyboard 122 that is received from the web browser.

A determination of when a callback is received is made (block 406). As noted in the preceding discussion, callbacks 120 may be generated responsive to a variety of triggers. In the above example, a callback 120 may be performed and communicated by the animation component 112 initially when the storyboard 122 for the selectable control bar scrolling is scheduled. The callback 120 may describe an initial position of the selectable control bar. Additional callbacks 120 responsive to other triggers and/or conditions may be communicated at other times before output of the selectable control bar animation.

When a callback is received, the storyboard in modified based on the callback (block 408). For instance, web browser may update a storyboard for the selectable control bar animation with additions, changes, and/or deletions based on the callback 120 that describes the initial position. The web browser may also cancel the storyboard 122.

Once the modifications according to block 408 have been made, procedure 400 may proceed to block 410. Procedure 400 also proceeds to block 410 when it is determined in block 408 that a callback has not been received. In either case, a determination is made of when to get variable values for the animation (block 410). This may occur when an application 110 determines it is time to draw/render a frame of the animation for output. For instance, web browser may determine when it is time to update a user interface 136 that is output for display on display device 134. Web browser may also be informed by animation component 112 that a scheduled storyboard 112 is about to begin.

When the web browser determines that it is not time to draw the frame, procedure 400 may return to block 406 where the web browser may again determine if a callback 120 has been received. Thus, multiple callbacks 120 may be received that cause corresponding modifications to the storyboard 122. It is to be noted that, while illustrated sequentially in FIG. 4, the callback determination (block 406) and get variables determination (block 410) by web browser (e.g., application 110) may occur in different orders, concurrently, and/or repetitively between scheduling of an animation and drawing of the frames for the animation. In other words, web browser may continue to monitor, receive, and/or detect callbacks 120 and to make get variables determinations in the time period between scheduling a storyboard 122 with animation component 112 and draws of the corresponding frame or frames of the animation.

When web browser determines that it is time to get variable values for a frame of the animation, variable values are obtained to output a frame (block 412), and the frame is output (block 414). For instance, the web browser may form a request to get variables values that is communicated to the animation component 112. The “get variables” request may cause the animation component 112 to perform calculations on behalf of the web browser for the selectable control bar animation. Additionally or alternatively, animation component 112 may make a determination of when to output the selectable control bar animation and proceed with calculations on behalf of the web browser. In each case, animation component 112 may communicate the results of the calculations to the web browser through the animation manger 114. Web browser may then use the communicated results to output the selectable control bar animation. In particular, the web browser may draw an individual frame of the selectable control bar animation based upon the values of the variables received from the animation component responsive to the “get variables” request. Each successive frame in the animation may be processed and output according to the storyboard 122 in this manner. For example, web browser may interact with the operating system 108 and/or a display driver 132 to cause rendering on the display device 134 of a user interface 136 including the selectable control bar animation.

Conclusion

Although the dynamic animation scheduling techniques have been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. One or more computer-readable media storing instructions executable by a computing device to:
receive via an interface a storyboard from an application of the computing device, the storyboard defining an animation as one or more transitions applied to one or more variables;
schedule the animation according to the storyboard; and
communicate one or more callbacks to the application to enable dynamic modifying of the scheduled animation.

2. One or more computer-readable media as recited in claim 1, wherein the instructions to receive, schedule, and communicate are implemented by an animation component that is integrated with an operating system of the computing device.

3. One or more computer-readable media as recited in claim 1, wherein the instructions are further executable to:
log modifications to the storyboard made by the application during the one or more callbacks in a tracking log; and
use the tracking log to undo the modifications when expected values of the one or more variables used by the application to make the modifications are invalidated.

4. One or more computer-readable media as recited in claim 1, wherein the instructions are further executable to:
receive modifications to the storyboard that are communicated by the application responsive to the one or more callbacks; and
modify the storyboard accordingly.

5. One or more computer-readable media as recited in claim 1, wherein the instructions are further executable to:
receive a request from the application to get values of the one or more variables;
perform calculations on behalf of the application according to the storyboard; and
communicate results of the calculations to the application to enable output of the animation.

6. One or more computer-readable media as recited in claim 1, wherein at least one of said one or more callbacks is communicated to the application multiple times.

7. One or more computer-readable media as recited in claim 1, wherein multiple said callbacks are communicated prior to a scheduled time for the animation based upon one or more of:
initial scheduling of the storyboard;
a change in one or more assumptions used to construct the storyboard;
scheduling of a different storyboard;
removal of another storyboard from a schedule of animations;
an offset specified by the application in the storyboard; or
a defined amount of time before a scheduled time for the storyboard.

8. One or more computer-readable media as recited in claim 1, wherein one of said one or more callbacks occurs for an offset time specified by the application in the storyboard.

9. One or more computer-readable media as recited in claim 1, wherein the storyboard references the one or more transitions from a transition library.

10. A method comprising:
communicating a storyboard to schedule an animation with an animation component;
receiving a callback from the animation component;
modifying the storyboard based upon the received callback;
obtaining variable values calculated by the animation component according to the modified storyboard; and
outputting the animation based upon the obtained variable values.

11. A method as recited in claim 10, wherein the storyboard describes the animation in terms of variables and transitions for the variables.

12. A method as recited in claim 11, wherein the callback describes an animation state that includes values of the variables described in the storyboard.

13. A method as recited in claim 10, further comprising instantiating an animation manager to provide an interface to the animation component.

14. A method as recited in claim 10, wherein updating the storyboard includes communicating a request to the animation component to modify the storyboard.

15. A method as recited in claim 14, wherein the request is configured to schedule another callback from the animation component.

16. A method as recited in claim 10, further comprising
receiving an additional callback from the animation component before outputting the animation; and
modifying the storyboard based upon the additional callback.

17. A computing device comprising:
a processor;
memory;
an operating system, stored in the memory and executable via the processor, the operating system including an animation component configured to:
schedule an animation according to a storyboard;
generate one or more callbacks to permit modifying of the animation when scheduled; and
perform calculations for the animation according to the storyboard; and
an application, stored in the memory and executable via the processor, the application configured to:
communicate the storyboard defining the animation as one or more transitions applied to one or more variables to the animation component;
receive callbacks from the animation component;
modify the scheduled animation responsive to the received one or more callbacks;
request performance of the calculations for the animation by the animation component; and
output the animation using the calculations received from the animation component responsive to the request.

18. A computing device as recited in claim 17, wherein the animation component is implemented as a dynamic link library (DLL) of the operating system.

19. A computing device as recited in claim 18, further comprising an animation manager exposable to provide an interface through which the application interacts with the animation component.

20. A computing device as recited in claim 19, wherein the animation manager is a Component Object Method (COM) object exposed by the application through the animation component.
